(19) United States
(12) Patent Application Publication
(10) Pub. No.: US 2010/0164967 A1
(43) Pub. Date: Jul. 1, 2010

(54) DISPLAY APPARATUS AND METHOD OF DRIVING THE SAME

(75) Inventor: Sang-Keun LEE, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/478,236

(22) Filed: Jun. 4, 2009

(30) Foreign Application Priority Data
Dec. 26, 2008 (KR) 10-2008-0134739

(51) Int. Cl. G06T 15/00

(52) U.S. Cl. 345/522

(57) ABSTRACT

A display apparatus includes; a signal controller which receives an image and input control signals and generates a modified image, and a data driver receives the modified image, samples data information from the modified image using data clock information, and generates a data voltage, the signal controller includes; a receiver which receives the input control signals and generates a control clock signal, an image signal processor receives the image and generates a data signal synchronized with the control clock signal, and a transmitter receives the data signal and generates the modified image, and the data information is generated by sampling the data signal, wherein the transmitter includes; a delay buffer which delays the data signal according to whether sampling clock signals have been delayed from the control clock signal, and a sampler samples the delayed data signal in response to the sampling clock signals and generates the data information.

This application claims priority from Korean Patent Application No. 10-2008-0134739, filed on Dec. 26, 2008, and all the benefits accruing therefrom under 35 U.S.C. §119, the contents of which in its entirety are herein incorporated by reference.

### BACKGROUND OF THE INVENTION

1. Field of the Invention

The present invention relates to a display apparatus and a method of driving the same.

2. Description of the Related Art

Flat panel displays (“FPDs”), such as organic light-emitting diode displays (“OLEDs”), plasma display panels (“PDPs”), and liquid crystal displays (“LCDs”), are being actively developed to replace heavy and large cathode ray tubes (“CRTs”).

PDPs typically display characters or images using plasma generated by a gas discharge, and OLEDs typically display characters or images using electroluminescence of specific organic materials or polymers. In addition, LCDs typically apply an electric field to a liquid crystal layer interposed between two glass substrates and control the intensity of the electric field to adjust the amount of light that passes through the liquid crystal layer. In this way, LCDs display a desired image.

In particular, LCDs and OLEDs each typically include a display panel, a gate driver, a gray voltage generator, a data driver, and a signal controller. The display panel includes pixels, each having a switching device, and display signal lines examples of which may include gate lines and data lines. The gate driver turns the switching device of each pixel on or off by transmitting a gate signal to each gate line, and the gray voltage generator generates a plurality of gray voltages. The data driver selects a gray voltage, which corresponds to image data, from the gray voltages and applies the selected gray voltage to each data line as a data voltage. The signal controller controls the display panel, the gate driver, the gray voltage generator, and the data driver.

Each of the above drivers typically receives a voltage required for its operation and changes the received voltage into a plurality of voltages required for its operation. For example, the gate driver receives a gate-on voltage and a gate-off voltage and alternately applies the gate-on voltage and the gate-off voltage to each gate line as a gate signal. The gray voltage generator receives a predetermined reference voltage, divides the reference voltage into a plurality of voltages, typically by using a resistor, and provides the voltages to the data driver.

In order to realize a display apparatus with a large screen and high resolution, a technology for transmitting data at high speed when the display apparatus is driven is required. In particular, a point-to-point intra-panel interface using a point-to-point method may be used for high-speed transmission of data signals between a signal controller and a data driver. A data driver may include a plurality of sub-data drivers. In an intra-panel interface using the point-to-point method, each of the sub-data drivers is connected to a signal controller by independent wiring. Therefore, an impedance mismatch is reduced compared to when a conventional multi-drop method in which a plurality of sub-data drivers are connected to a signal controller by one wiring is used, thereby reducing electromagnetic interference (“EMI”).

In addition, if a clock signal is embedded in a data signal, e.g., an embedded clock method, using a multi-level signaling method, no additional wiring is required to transmit the clock signal. Accordingly, skews that arise when the data signal and the clock signal are transmitted via separate wirings can be prevented.

In the embedded clock method, however, when the clock signal is embedded in the data signal, delays are often experienced due to external factors or internal characteristics of the intra-panel interface. Such delays may cause errors in some data signals, in particular, in data generated immediately after the initiation of data signal transmission. As a result, defects may occur in the quality of a displayed image.

### BRIEF SUMMARY OF THE INVENTION

Exemplary embodiments of the present invention provide a display apparatus which can display an image without defects and a method of driving the display apparatus.

However, exemplary embodiments of the present invention are not restricted to the one set forth herein. The above and other aspects, advantages and features of the present invention will become more apparent to one of ordinary skill in the art to which the present invention pertains by referencing the detailed description of the present invention given below.

According to an exemplary embodiment of the present invention, a display apparatus includes; a signal controller which receives an original image signal and a plurality of input control signals and generates a modified image signal, and a data driver which receives the modified image signal, samples data information from the modified image signal using data clock information, and generates a data voltage corresponding to the data information, wherein the signal controller includes; a receiver which receives the plurality of input control signals and generates a control clock signal, an image signal processor which receives the original image signal and generates a data signal synchronized with the control clock signal, and a transmitter which receives the data signal and generates the modified image signal, wherein the modified image signal includes the data clock information embedded in the data information and wherein the data information is generated by sampling the data signal, wherein the transmitter includes; a delay buffer which delays the data signal according to whether each of a plurality of sampling clock signals has been delayed from the control clock signal, and a sampler which samples the delayed data signal in response to each of the plurality of sampling clock signals and generates the data information.

According to another exemplary embodiment of the present invention, a method of driving a display apparatus includes; comparing a control clock signal with each of a plurality of sampling clock signals, delaying a data signal according to whether each of the plurality of sampling clock signals has been delayed from the control clock signal, providing the delayed data signal to a sampler, sampling the delayed data signal in response to each of the plurality of sampling clock signals, generating data information using the sampler, generating an image signal by embedding data clock information in the data information in response to a modulation control signal; receiving the image signal and sampling the data information from the image signal using the data clock information, and generating a data voltage corresponding to the data information.

### BRIEF DESCRIPTION OF THE DRAWINGS

The above and other aspects, advantages and features of the present invention will become more apparent by describing in further detail exemplary embodiments thereof with reference to the attached drawings, in which:

FIG. 1 is a block diagram of an exemplary embodiment of a display apparatus according to of the present invention;

FIG. 2 is an equivalent circuit diagram of an exemplary embodiment of a pixel shown in FIG. 1;

FIG. 3 is a block diagram of an exemplary embodiment of a signal controller shown in FIG. 1;

FIG. 4 is a diagram illustrating exemplary embodiments of image signals according to the present invention;

FIG. 5 is a block diagram of an exemplary embodiment of a transmitter shown in FIG. 3;

FIG. 6 is a block diagram of an exemplary embodiment of a delay buffer shown in FIG. 5;

FIG. 7 is a diagram illustrating an exemplary embodiment of the operation of the transmitter included in the exemplary embodiment of a display apparatus of FIG. 1;

FIG. 8 is a diagram illustrating one exemplary embodiment of a delay controller according to the present invention; and

FIG. 9 is a diagram illustrating the operation of the exemplary embodiment of a delay controller shown in FIG. 8.

### DETAILED DESCRIPTION OF THE INVENTION

The invention now will be described more fully hereinafter with reference to the accompanying drawings, in which embodiments of the invention are shown. The present invention may, however, be embodied in many different forms and should not be construed as being limited to the embodiments set forth herein. Rather, these embodiments are provided so that this disclosure will be thorough and complete and will fully convey the scope of the invention to those skilled in the art. Like reference numerals refer to like elements throughout the specification.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated steps, operations, components, and/or elements, but do not preclude the presence or addition of one or more other steps, operations, components, elements, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings.

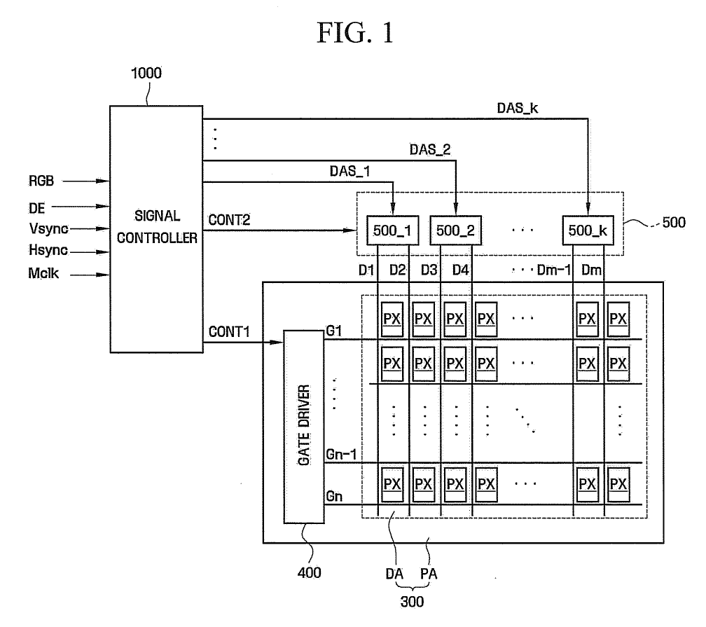

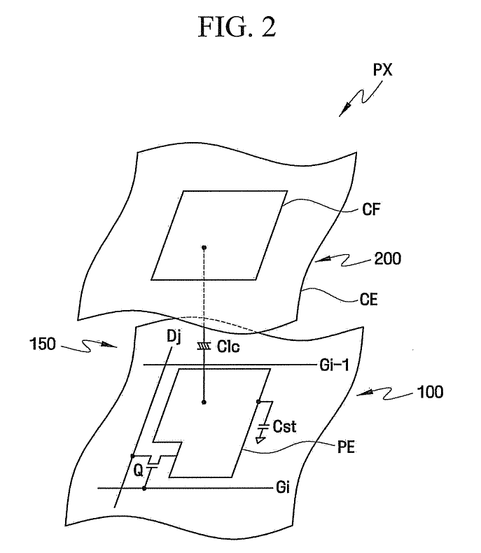

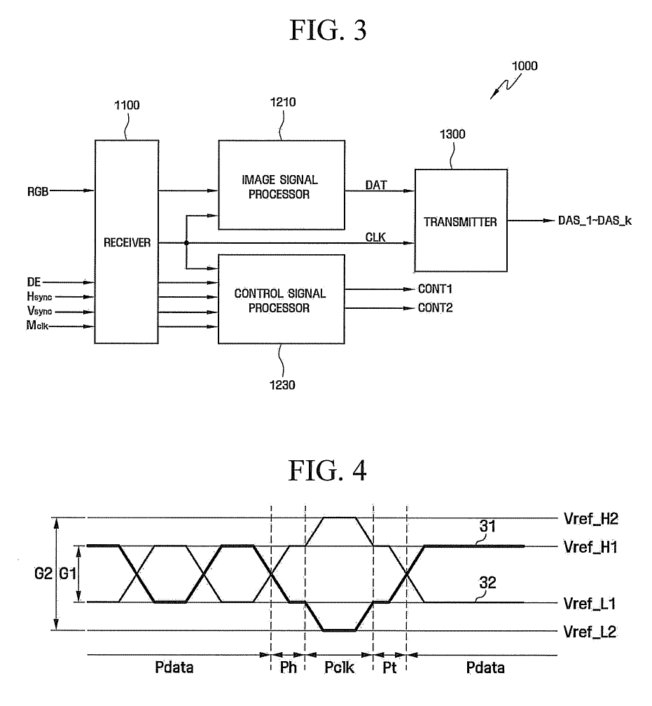

FIG. 1 is a block diagram of an exemplary embodiment of a display apparatus according to the present invention. FIG. 2 is an equivalent circuit diagram of an exemplary embodiment of one of a plurality of pixels PX shown in FIG. 1. FIG. 3 is a block diagram of an exemplary embodiment of a signal controller 1000 shown in FIG. 1. In the exemplary embodiment of a display apparatus of FIG. 1, two data lines are connected to each sub-data driver. However, alternative exemplary embodiments include configurations wherein more or fewer data lines may be connected to each sub-data driver, and the present invention is not limited thereto.

Referring to FIGS. 1 and 2, the exemplary embodiment of a display apparatus includes a display panel 300, the signal controller 1000, a gate driver 400, and a data driver 500.

The display panel 300 includes a plurality of gate lines G1 through Gn, wherein n is an natural number, a plurality of data lines D1 through Dm, wherein m is an natural number, and a plurality of pixels PX. The display panel 300 may be divided into a display region DA where images are displayed and a non-display region PA where no images are displayed.

To display images, the display region DA includes a first substrate 100 on which the gate lines G1 through Gn, the data lines D1 through Dm, a plurality of switching devices Q and a plurality of pixel electrodes PE are formed, a second substrate 200 on which a color filter CF and a common electrode CE are formed, and a liquid crystal layer 150 which is interposed between the first and second substrates 100 and 200. Alternative exemplary embodiments include configurations wherein the color filter CF and the common electrode CE may be formed on the first substrate 100. In the present exemplary embodiment, the gate lines G1 through Gn may extend in a substantially row direction to be substantially parallel to each other, and the data lines D1 through Dm may extend in a substantially column direction to be substantially parallel to each other. The non-display region PA may correspond to a region of the display apparatus where the first substrate 100 is not overlapped by the second substrate, e.g., the first substrate 100 is wider than the second substrate 200.

Referring to FIG. 2, in each of the pixels PX shown in FIG. 1, the color filter CF may be formed on a region of the common electrode CE on the second substrate 200 to face the pixel electrode PE of the first substrate 100. Each of the pixels PX may be connected to an i^{th} (wherein i is an natural number from 1 to n) gate line Gi and a j^{th} (wherein j is an natural number from 1 to m) data line Dj. In addition, each of the pixels PX may include the switching device Q, which is connected to the i^{th} gate line Gi and the j^{th} data line Dj, and a liquid crystal capacitor Clc and a storage capacitor Cst which are connected to the switching device Q. Exemplary embodiments include configurations wherein the storage capacitor Cst may be omitted. Exemplary embodiments of the switching device Q may include a thin-film transistor made of amorphous silicon (“a-Si”) (hereinafter, referred to as an “a-Si TFT”). In the exemplary embodiment illustrated in FIG. 2, the color filter CF is formed on the second substrate 200 having the common electrode CE. However, the present invention is not limited thereto, and exemplary embodiments include configurations wherein the color filter CF may also be formed on the first substrate 100 as described above.

The signal controller 1000 receives, e.g., from an external graphics controller (not shown), an original image signal RGB and input control signals for controlling the display of the original image signal RGB and provides image signals DAS_1 through DAS_k, gate control signals CONT1, and data control signals CONT2 to the other components of the display apparatus, specifically the gate driver 400 and the data driver 500. In the present exemplary embodiment, the input control signals may include a vertical synchronization signal Vsync, a horizontal synchronization signal Hsync, a main clock signal Mclk, and a data enable signal DE.

Referring to FIG. 3, the present exemplary embodiment of a signal controller 1000 includes a receiver 1100, a control signal processor 1230, an image signal processor 1210, and a transmitter 1300.

Specifically, the receiver 1100 receives the original image signal RGB and the input control signals from the external graphics controller using a low-voltage differential signaling (“LVDS”) method and provides the original image signal RGB and the input control signals to the image signal processor 1210 and the control signal processor 1230, respectively, as will be described in more detail below. In addition, the receiver 1100 generates a synchronization control signal such as a control clock signal CLK used for signal processing. Here, the LVDS method is one exemplary embodiment of a method used by the display apparatus to receive signals from the external graphics controller. However, alternative exemplary embodiments include configurations wherein various methods such as a transition minimized differential signaling (“TMDS”) method may alternatively or additionally be used.

The control signal processor 1230 generates the gate control signals CONT1 and the data control signals CONT2 using the input control signals and the control clock signal CLK received through the receiver 1100. The gate control signals CONT1 are provided to the gate driver 400 to control the operation of the gate driver 400. Exemplary embodiments of the gate control signals CONT1 may include a scan start signal for starting the operation of the gate driver 400 in each frame and at least one gate clock signal for controlling the output cycle of a gate-on voltage. In addition, exemplary embodiments of the gate control signals CONT1 may include an output enable signal for controlling the duration of the gate-on voltage.

The data control signals CONT2 are provided to the data driver 500 to control the operation of the data driver 500. Exemplary embodiments of the data control signals CONT2 may include a horizontal start signal for starting the operation of the data driver 500 and a load signal for instructing the output of data voltages to data lines D1 through Dm. Exemplary embodiments of the data control signals CONT2 may further include an inversion signal for inverting the polarity of a data voltage with respect to a data common voltage Vcom.

The image signal processor 1210 processes the original image signal received through the receiver 1100 and generates a data signal DAT, in one exemplary embodiment the data signal DAT may be a modified data signal. In detail, the image signal processor 1210 may process the original image signal RGB in various ways to generate the data signal DAT. In one exemplary embodiment, the image signal processor 1210 may gamma-correct the original image signal RGB to be suitable for the display apparatus, may over-drive the original image signal RGB to compensate for response time of liquid crystals based on the gray-level difference between frames, or process the original image signal RGB to produce an interpolated image signal corresponding to an interpolated frame which is inserted between every two successive frames, or a combination thereof.

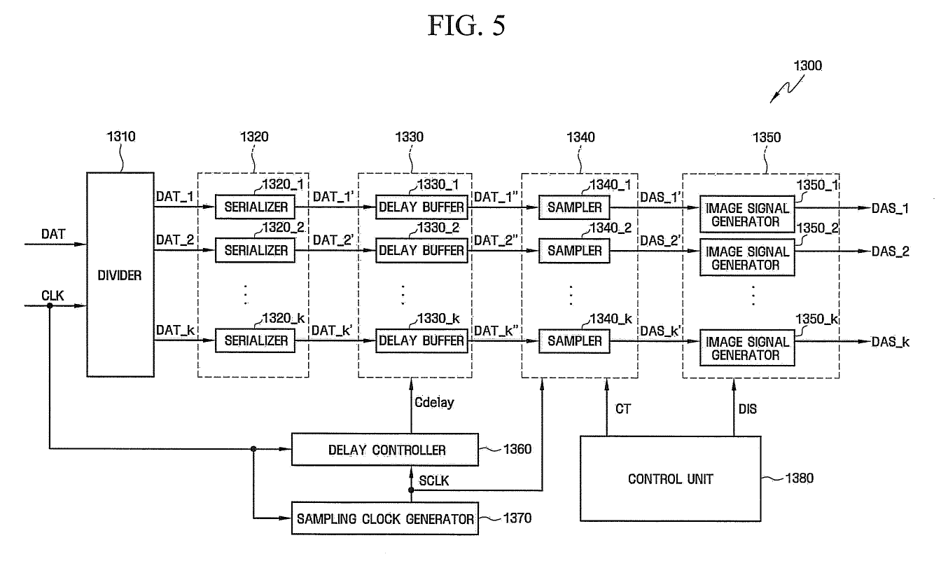

The transmitter 1300 receives the data signal DAT synchronized with the control clock signal CLK, generates the image signals DAS_1 through DAS_k, each of which includes data clock information embedded in data information generated by sampling the data signal DAT, and provides the image signals DAS_1 through DAS_k to a plurality of sub-data drivers 500_1 through 500_{—}k, respectively. In the present exemplary embodiment, the data clock information may be used by the sub-data drivers 500_1 through 500_{—}k to sample data information from the image signals DAS_1 through DAS_k, respectively. A more detailed configuration of the transmitter 1300 will be described in more detail later with reference to FIG. 5, and the image signals DAS_1 through DAS_k will first be described with reference to FIG. 4.

FIG. 4 is a diagram illustrating exemplary embodiments of the image signals DAS_1 through DAS_k according to the present invention

Referring to FIG. 4, each of the image signals DAS_1 through DAS_k according to the present exemplary embodiment may be a differential pair signal which includes first and second signals 31 and 32. Each of the image signals DAS_1 through DAS_k may also be a multi-level signal having different voltage levels in a first section (hereinafter, referred to as a data section Pdata) which includes the data information and a second section (hereinafter, referred to as a data clock section Pclk) which includes the data information and the data clock information.

Specifically, the first and second signals 31 and 32 of each of the image signals DAS_1 through DAS_k may swing between voltages Vref_H1 and Vref_L1 in the data section Pdata and swing between Vref_H2 and Vref_L2 in the data clock section Pclk. That is, an absolute value G1 of the difference between levels of the first and second signals 31 and 32 in the data section Pdata may be different from an absolute value G2 of the difference between the levels of the first and second signals 31 and 32 in the data clock section Pclk. Thus, even if each of the sub-data drivers 500_1 through 500_{—}k respectively receive the image signals DAS_1 through DAS_k via a single line, they may be provided with the data information and the data clock information according to an absolute value of the difference between the levels of the first and second signals 31 and 32.

The data information included in the data section Pdata of each of the image signals DAS_1 through DAS_k may be represented based on the difference between the levels of the first and second signals 31 and 32. In one exemplary embodiment, when the level of the first signal 31 is higher than that of the second signal 32 in the data section Pdata of each of the image signals DAS_1 through DAS_k, the data information may be represented by “1.” On the other hand in such an exemplary embodiment, when the level of the second signal 32 is higher than that of the first signal 31, the data information may be may be represented by “0.”

A clock head section Ph or a clock tail section Pt may be interposed between the data clock section Pclk and the data section Pdata, so that the last data information of the data section Pdata before the data clock section Pclk can be provided to the sub-data drivers 500_1 through 500_{—}k stably without being affected by electromagnetic interference (“EMI”).

In the exemplary embodiment illustrated in FIG. 4, each of the image signals DAS_1 through DAS_k includes the clock head section Ph and the clock tail section Pt. However, the present invention is not limited thereto. In other exemplary embodiments of the present invention, each of the image signals DAS_1 through DAS_k may selectively include one of the clock head section Ph or the clock tail section Pt.

In addition, in the exemplary embodiment illustrated in FIG. 4, the first and second signals 31 and 32 of each of the image signals DAS_1 through DAS_k swing between Vref_H2 and Vref_L2 in the data clock section Pclk. However, the present invention is not limited thereto. In other exemplary embodiments of the present invention, the first and second signals 31 and 32 may swing between Vref_H2 and Vref_L1 or between Vref_H1 and Vref_L2 in the data clock section Pclk.

The gate driver 400 receives the gate control signals CONT1 and a gate-off voltage Voff and provides the gate-on voltage to the gate lines G1 through Gn sequentially. Specifically, in the present exemplary embodiment, the gate driver 400 is enabled in each frame in response to the scan start signal and sequentially provides the gate-on voltage to the gate lines G1 through Gn in response to the gate clock signal.

As shown in FIG. 1, an exemplary embodiment of the gate driver 400 may be formed in the non-display region PA of the display panel 300 and thus connected to the display panel 300. However, the present invention is not limited thereto. Alternative exemplary embodiments include configurations wherein the gate driver 400 may be mounted on flexible printed circuit films in the form of integrated circuit chips and then attached to the display panel 300 in the form of tape carrier packages (“TCPs”). Alternative exemplary embodiments also include configurations wherein the gate driver 400 may be mounted on a separate printed circuit board (“PCB”). While the present exemplary embodiment of a gate driver 400 is disposed on a side of the display panel 300 in the drawing, the present invention is not limited thereto. That is, in alternative exemplary embodiments of a display apparatus according to the present invention, the gate driver 400 may include first and second gate drivers which are disposed on both sides of the display panel 300, respectively.

The data driver 500 includes the sub-data drivers 500_1 through 500_{—}k and provides data voltages to the data lines D1 through Dm using gray voltages, the image signals DAS_1 through DAS_k, the data control signals CONT2, and other similar signals. Specifically, each of the sub-data drivers 500_1 through 500_{—}k may detect the data clock information from a corresponding one of the image signals DAS_1 through DAS_k by using the difference between the levels of the first and second signals 31 and 32 of the corresponding one of the image signals DAS_1 through DAS_k and generate a data clock signal based on the detected data clock information. Then, the data driver 500 may sample the data information from the corresponding one of the image signals DAS_1 through DAS_k in response to the data clock signal. Finally, the data driver 500 may generate a data voltage, which corresponds to the data information, using a plurality of gray voltages provided by a gray voltage provider (not shown) and provide the generated data voltage to corresponding ones of the data lines D1 through Dm.

In the present exemplary embodiment, each of the sub-data drivers 500_1 through 500_{—}k is connected to the signal controller 1000 in a point-to-point manner. That is, each of the sub-data drivers 500_1 through 500_{—}k is connected to the signal controller 1000 by independent wiring. Thus, the present exemplary embodiment of a display apparatus has a relatively smaller impedance mismatch than a comparative display apparatus in which a plurality of sub-data drivers are connected to a single signal line, i.e., in a multi-drop manner, thereby reducing noise caused by EMI.

In one exemplary embodiment, the sub-data drivers 500_1 through 500_{—}k may be integrated chips, and the integrated chips may be connected to the display panel 300 in the form of TCPs. However, the present invention is not limited thereto, and exemplary embodiments include configurations wherein the data driver 1000 may also be formed in the non-display region PA of the display panel 300.

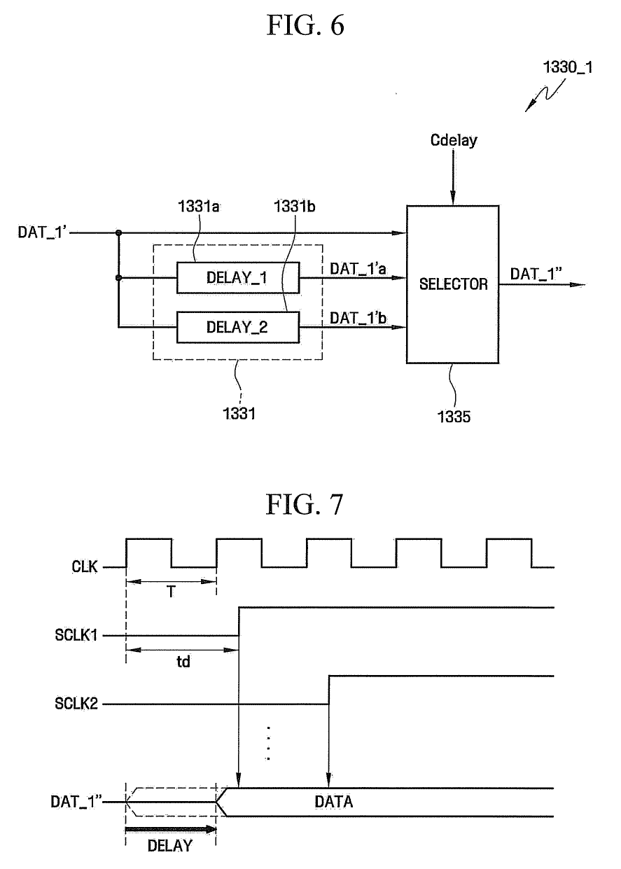

FIG. 5 is a block diagram of an exemplary embodiment of the transmitter 1300 shown in FIG. 3. FIG. 6 is a block diagram of an exemplary embodiment of one of a delay buffer 1330_1 through 1330_{—}k shown in FIG. 5. In the exemplary embodiment illustrated in FIG. 6, each of the delay buffers 1330_1 through 1330_{—}k includes two delay units. However, the present invention is not limited thereto, and alternative exemplary embodiments include configurations wherein each of the delay buffers 1330_1 through 1330_{—}k may also include two or more delay units.

Referring to FIG. 5, the present exemplary embodiment of a transmitter 1300 includes a sampling clock generator 1370, a divider 1310, a serialization circuit 1320, a delay controller 1360, a delay buffer circuit 1330, a sampling circuit 1340, an image signal generation circuit 1350, and a control unit 1380.

The sampling clock generator 1370 generates sampling clock signals SCLK using the control clock signal CLK. The sampling clock signals SCLK are used by samplers 1340_1 through 1340_{—}k to sample the data signal DAT. The sampling clock signals SCLK, e.g., first and second sampling clock signals SCLK1 and SCLK2, may have different phases as shown in FIG. 7. In one exemplary embodiment, the sampling clock generator 1370, which generates the sampling clock signals SCLK, may include a phase-locked loop (“PLL”) circuit or a delay-locked loop (“DLL”) circuit.

The divider 1310 may receive the data signal DAT serially, divide the data signal DAT in predetermined units into a plurality of segments (hereinafter, the segments will be referred to as a plurality of divided data signals DAT_1 through DAT_k), and provide the divided data signals DAT_1 through DAT_k to a plurality of serializers 1320_1 through 1320_{—}k, respectively. In the present exemplary embodiment, the number of predetermined units may be substantially equal to units of data signals delivered to the number of pixels in each row which corresponds to the number of the data lines D1 through Dm connected to each of the sub-data drivers 500_1 through 500_{—}k.

The serialization circuit 1320 includes the serializers 1320_1 through 1320_{—}k. The serializers 1320_1 through 1320_{—}k serialize the divided data signals DAT_1 through DAT_k and provide the serialized data signals (hereinafter, the serialized data signals will be indicated by reference numerals DAT_1′ through DAT_k′) to the delay buffers 1330_1 through 1330_{—}k, respectively.

The delay controller 1360 receives and compares the control clock signal CLK and each of the sampling clock signals SCLK and provides a delay control signal Cdelay to the delay buffer circuit 1330. Specifically, the delay controller 1360 may compare the control clock signal CLK with each of the sampling clock signals SCLK and detect a delay time of each of the sampling clock signals SCLK from the control clock signal CLK (hereinafter, the phrase “the delay time of each of the sampling clocks SCLK from the control clock signal CLK” will be shortened to “the delay time of each of the sampling clock signals SCLK”). Then, the delay controller 1360 may provide the delay control signal Cdelay to each of the delay buffers 1330_1 through 1330_{—}k based on the delay time of each of the sampling clock signals SCLK and a period of the control clock signal CLK.

Referring to FIG. 7, a data signal, specifically, a delayed data signal DAT_1″ obtained by delaying the serialized data signal DAT_1′, (hereinafter, the delayed data signals will be indicated by reference numerals DAT_1″ through DAT_k″) may be provided in synchronization with the control clock signal CLK, and each of the samplers 1340_1 through 1340_{—}k may generate the data information by sampling the delayed data signals DAT_1″ through DAT_k″, e.g., the delayed data signal DAT_1″, in response to one of the sampling clock signals SCLK, e.g., the first sampling clock signal SCLK1. In such an exemplary embodiment, the delay time “td” of each of the sampling clock signals SCLK may be a time interval between a first rising edge of the control clock signal CLK and that of each of the sampling clock signals SCLK, e.g., the first sampling clock signal SCLK1.

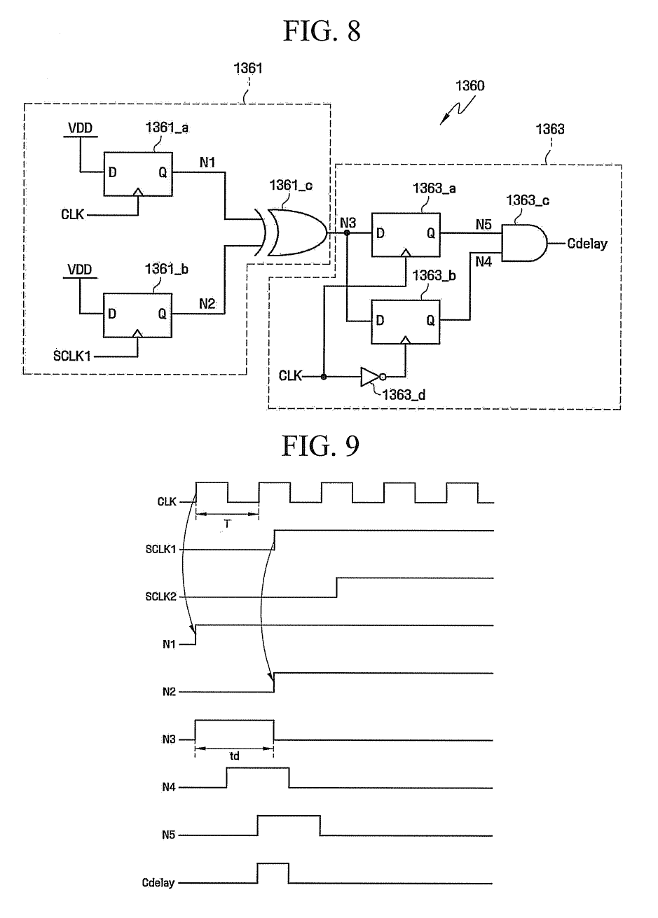

If the data information included in the data signal, e. g., the delayed data signal DAT_1″, is composed of a plurality of bits and if each bit of the data information is provided in response to each rising edge of the control clock signal CLK, the first rising edge of the control clock signal CLK may be a time when a first bit of the data information is provided. The delay controller 1360 will be described in more tail later with reference to FIGS. 8 through 11.

The delay buffer circuit 1330 includes the delay buffers 1330_1 through 1330_{—}k. The delay buffers 1330_1 through 1330_{—}k delay the serialized data signals DAT_1′ through DAT_k′ according to whether, and by how long, each of the sampling clock signals SCLK has been delayed from the control clock signal CLK and provide the delayed data signals DAT_1′ through DAT_k′ to the samplers 1340_1 through 1340_{—}k, respectively. Specifically, the delay buffers 1330_1 through 1330_{—}k may delay the serialized data signals DAT_1′ through DAT_k′ by a predetermined period of time in response to the delay control signal Cdelay received from the delay controller 1360 and provide the delayed data signals DAT_1″ through DAT_k″ to the samplers 1340_1 through 1340_{—}k, respectively.

In the present exemplary embodiment, the predetermined period of time may be long enough so that the samplers 1340_1 through 1340_{—}k stably sample the delayed data signals DAT_1″ through DAT_k″ and generate the data information even when the sampling clock signals SCLK are delayed due to routine errors of the sampling clock generator 1370. In one exemplary embodiment, the predetermined period of time may be a multiple of a period of the control clock signal CLK. If the delay time of each of the sampling clock signals SCLK is longer than a period of the control clock signal CLK and shorter than two periods of the control clock signal CLK, the delay buffers 1330_1 through 1330_{—}k may delay the serialized data signals DAT_1′ through DAT_k′ by at least one period of the control clock signal CLK and provide the delayed data signals DAT_1″ through DAT_k″ to the samplers 1340_1 through 1340_{—}k, respectively.

Referring to FIG. 6, each of the delay buffers 1330_1 through 1330_{—}k may include a delay circuit 1331 and a selector 1335. In the present exemplary embodiment, the delay circuit 1331 includes one or more delay units, e.g., first and second delay units 1331a and 1331b, and each of the delay units delays a data signal, e.g., the serialized data signal DAT_1′, received from a respective serializer e.g., the serializer 1320_1, by a predetermined period of time. If the delay circuit 1331 includes a plurality of delay units, e.g., the first and second delay units 1331a and 1331b, the delay units may delay the serialized data signal DAT_1′ by different periods of time. In one exemplary embodiment, the first delay unit 1331a may delay the serialized data signal DAT_1′ by a period of time corresponding to a period of the control clock signal CLK and the second delay unit 1331b may delay the serialized data signal DAT_1′ by a period of time corresponding to two periods of the control clock signal CLK. Alternative exemplary embodiments include configurations wherein the first and second delay units 1331a and 1331b may delay the serialized data signal DAT_1′ through DAT_k′ by different periods of the control clock signal CLK, e.g., by three or more periods of the control clock signal.

The selector 1335 receives the serialized data signal DAT_1′ directly from the serializer 1320_1, receives delayed versions DAT_1′a and DAT_1′b of the serialized data signal DAT_1′ from the delay circuit 1331, and selectively outputs the received signals in response to the delay control signal Cdelay. In one exemplary embodiment, when the delay time of each of the sampling clock signals SCLK is shorter than a period of the control clock signal CLK, the selector 1335 may output the serialized data signal DAT_1′ which has not been delayed. On the other hand, when the delay time of each of the sampling clock signals SCLK is longer than a period of the control clock signal CLK, the selector 1335 may output the delayed versions DAT_1′a and DAT_1′b of the serialized data signal DAT_1.′ Even when the delay time of each of the sampling clock signals SCLK is longer than a period of the control clock signal CLK, the selector 1335 may selectively output the delayed versions DAT_1′a and DAT_1′b of the serialized data signal DAT_1′, which are provided by the first and second delay units 1331a and 1331b, respectively, based on the delay time of each of the sampling clock signals SCLK.

The sampling circuit 1340 includes the samplers 1340_1 through 1340_{—}k. The samplers 1340_1 through 1340_{—}k respectively sample the delayed data signals DAT_1″ through DAT_k″ in response to each of the sampling clock signals SCLK and generate the data information. Then, the samplers 1340_1 through 1340_{—}k embed data clock information in the data information in response to a modulation control signal CT and generate pre-image signals DAS_1′ through DAS_k′. Specifically, the samplers 1340_1 through 1340_{—}k respectively sample the delayed data signals DAT_1″ through DAT_k″, which are synchronized with the control clock signal CLK, and generate the data information. Then, the samplers 1340_1 through 1340_{—}k embed the data clock information in the data information at predetermined intervals and in response to the modulation control signal CT provided by the control unit 1380 in order to generate the pre-image signals DAS_1′ through DAS_k′.

The image signal generation circuit 1350 includes a plurality of image signal generators 1350_1 through 1350_{—}k. The image signal generators 1350_1 through 1350_{—}k respectively receive the pre-image signals DAS_1′ through DAS_k′ and generate the image signals DAS_1 through DAS_k, each being a differential pair signal, e.g., a signal having first and second signals as shown in FIG. 4. Specifically, the image signal generators 1350_1 through 1350_{—}k convert the delayed data signals DAT_1″ through DAT_k″, which are respectively included in the pre-image signals DAS_1′ through DAS_k′, and a differential pair signal into different levels in a section corresponding to the data clock signal, as shown in the period of the data clock section Pclk in FIG. 4, using an identification signal DIS provided by the control unit 1380. As a result, the image signal generators 1350_1 through 1350_{—}k respectively generate the image signals DAS_1 through DAS_k as shown in FIG. 4.

The control unit 1380 controls each component of the transmitter 1300 to generate the image signals DAS_1 through DAS_k, each having the data clock information embedded in the data information. In one exemplary embodiment, the control unit 1380 may provide the modulation control signal CT to the samplers 1340_1 through 1340_{—}k, so that the samplers 1340_1 through 1340_{—}k respectively output the pre-image signals DAS_1′ through DAS_k′. In such an exemplary embodiment, each of the pre-image signals DAS_1′ through DAS_k′ includes the data information sampled by the samplers 1340_1 through 1340_{—}k, respectively, and the data clock information embedded in the data information at predetermined time intervals. The control unit 1380 may also provide the identification signal DIS to the image signal generators 1350_1 through 1350_{—}k, so that the image signal generators 1350_1 through 1350_{—}k respectively output the image signals DAS_1 through DAS_k, each being a differential pair signal having different levels in the data section Pdata and the data clock section Pclk.

FIG. 7 is a diagram illustrating an exemplary embodiment of the operation of the transmitter 1300 included in the display apparatus of FIG. 1. In FIG. 7, only the first and second sampling clock signals SCLK1 and SCLK2 are illustrated for simplicity from among the plurality of sampling clock signals SCLK1-SCLKk having different phases. However, the present invention is not limited thereto. In addition, only the first image signal DAS_1 is illustrated in FIG. 7 for simplicity, but the present invention is not limited thereto. The operation of the transmitter 1300 may also apply to the other image signals DAS_2 through DAS_k.

Referring to FIGS. 5 and 7, each of the samplers 1340_1 through 1340_{—}k included in the present exemplary embodiment of a display apparatus samples the data signal DAT, which is provided in synchronization with a rising edge of the control clock signal CLK, in response to a rising edge of each of the first and second sampling clock signals SCLK1 and SCLK2 having different phases and generates the data information. In the present exemplary embodiment, the first and second sampling clock signals SCLK1 and SCLK2 having different phases may have lower frequencies than the control clock signal CLK, and the second sampling clock signal SCLK2 may be a signal obtained by delaying the first sampling clock signal SCLK1 by a predetermined period of time.

Specifically, in the present exemplary embodiment the sampler 1340_1 may sample the delayed data signal DAT_1″ in response to a rising edge of the first sampling clock signal SCLK1 and generate 1-bit data information. Then, the sampler 1340_1 may generate 1-bit data information in response to a rising edge of the second sampling clock signal SCLK2 that follows the first sampling clock signal SCLK1. That is, the sampling operation of the sampler 1340_1 is initiated by the first sampling clock signal SCLK1 and continued by a plurality of sampling clock signals, e.g., the second sampling clock signal SCLK2, provided sequentially with respect to the first sampling clock signal SCLK1.

In a comparative display apparatus, when the first sampling clock signal SCLK1 is delayed from the control clock signal CLK by a period of time, i.e., by the delay time td of the first sampling clock signal SCLK1, due to changes in external factors such as pressure, voltage, temperature, or other factors, or problems with the sampling clock generator 1370, the sampler 1340_1 may fail to sample the delayed data signal DAT_1″ in a stable manner. As a result, there may be errors in the data information.

Specifically, when the sampler 1340_1 has an error due to manufacturing problems, if the delayed data signal DAT_1″ is provided in synchronization with the control clock signal CLK as indicated by dotted lines in FIG. 7 while the first sampling clock signal SCLK1 is provided later than a period T of the control clock signal CLK, the sampler 1340_1 may fail to generate a first bit of the data information. Accordingly, defects may occur in image quality. For example, vertical stripes may be formed in an image displayed on the display panel 300.

However, the exemplary embodiment of a transmitter 1300 of the exemplary embodiment of a display apparatus delays the serialized data signal DAT_1′ based on a period T of the control clock signal CLK and the delay time td of the first sampling clock signal SCLK1, i.e., a period of time between the first rising edge of the control clock signal CLK and that of the first sampling clock signal SCLK1, and provides the delayed data signal DAT_1″ to the sampler 1340_1. In this regard, no defects occur in image quality.

Specifically, if the delay time td of the first sampling clock signal SCLK1 is longer than a period T of the control clock signal CLK and shorter than two periods 2T of the control clock signal CLK, the serialized data signal DAT_1′ may be delayed by one period T of the control clock signal CLK and provided accordingly to the sampler 1340_1. If the delay time td of the first sampling clock signal SCLK1 is longer than two periods 2T of the control clock signal CLK and shorter than three periods 3T of the control clock signal CLK, the serialized data signal DAT_1′ may be delayed by two periods 2T of the control clock signal CLK and provided accordingly to the sampler 1340_1, etc. In this way, the exemplary embodiment of a transmitter 1300 of the exemplary embodiment of a display apparatus can stably sample the data signal DAT and generate the data information, thereby preventing defects in image quality.

FIG. 8 is a diagram illustrating an exemplary embodiment of a delay controller 1360 according to the present invention. While the delay controller 1360 shown in FIG. 8 illustrates a comparison between the control clock signal CLK and the first sample clock signal SCLK1, other sample clock signals SCLK2 through SCLKk may be sequentially applied to the same terminal as the first sample clock signal SCLK1. FIG. 9 is a diagram illustrating an exemplary embodiment of the operation of the delay controller 1360 shown in FIG. 8.

Referring to FIGS. 8 and 9, the present exemplary embodiment of a delay controller 1360 compares each of the sampling clock signals SCLK, e.g., the first sampling clock signal SCLK1, and the control clock signal CLK and provides the delay control signal Cdelay to the delay buffer circuit 1330. The delay controller 1360 includes a delay detector 1361 and a delay signal generator 1363.

The delay detector 1361 detects the delay time of the sampling clock signals SCLK1 through SCLKk. For example, the delay detector 1361 detects the delay time td of the first sampling clock signal SCLK1, that is, a period of time between the first rising edge of the control clock signal CLK and that of the first sampling clock signal SCLK1.

The delay detector 1361 includes first and second flip-flops 1361_{—}a and 1361_{—}b and a NOR operator 1361_{—}c. Specifically, the first and second flip-flops 1361_{—}a and 1361_{—}b respectively provide outputs N1 and N2 at a high level in response to the control clock signal CLK and a rising edge of the first clock of each of the sampling clock signals SCLK1 through SCLKk, e.g., the first sampling clock signal SCLK1. Then, the NOR operator 1361_{—}c performs a NOR operation on the respective outputs N1 and N2 of the first and second flip-flops 1361_{—}a and 1361_{—}b and detects the delay time td of each of the sampling clock signals SCLK1 through SCLKk.

The delay signal generator 1363 provides the delay control signal Cdelay based on a period T of the control clock signal CLK and the delay time td of each of the sampling clock signals SCLK1 through SCLKk provided by the delay detector 1361. The delay signal generator 1363 includes third and fourth flip-flops 1363_{—}a and 1363_{—}b and an AND operator 1363_{—}c. Specifically, the third flip-flop 1363_{—}a of the delay signal generator 1363 receives an output N3 of the NOR operator 1361_{—}c and provides an output N5 in response to the control clock signal CLK. On the other hand, the fourth flip-flop 1363_{—}b receives the output N3 of the NOR operator 1361_{—}c and provides an output N4 in response to the control clock signal CLK inverted by an inversion operator 1363_{—}d.

The AND operator 1363_{—}c performs an AND operation on the respective outputs N5 and N4 of the third and fourth flip-flops 1363_{—}a and 1363_{—}b and provides the delay control signal Cdelay to the delay buffer circuit 1330. In one exemplary embodiment, if the delay time td of each of the sampling clock signals SCLK is longer than a period T of the control clock signal CLK as shown in FIG. 9, the delay control signal Cdelay at a high level may be provided.

A case where the serialized data signals DAT_1′ through DAT_k′ are delayed by a period T of the control clock signal CLK and provided accordingly to the samplers 1340_1 through 1340_{—}k, respectively, has been described above with reference to FIGS. 8 and 9. However, the present invention is not limited to this exemplary embodiment. It will be obvious to those skilled in the art to which the present invention pertains that, in other exemplary embodiments of the present invention, the serialized data signals DAT_1′ through DAT_k′ can be delayed by a multiple of a period T of the control clock signal CLK based on a period of time by which each of the sampling clocks SCLK has been delayed.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A display apparatus comprising:
a signal controller which comprises a receiver for receiving an original image signal and a plurality of input control signals and generating a control clock signal based on the plurality of the input control signals, an image signal processor for generating a data signal synchronized with the control clock signal based on the original image signal, and a transmitter for generating a modified image signal which includes data information generated by sampling the data signal and data clock information embedded in the data information; and
a data driver which samples the data information from the modified image signal using the data clock information, and generates a data voltage corresponding to the data information,
wherein the transmitter comprises:
a delay buffer which delays the data signal according to whether each of a plurality of sampling clock signals has been delayed from the control clock signal; and
a sampler which samples the delayed data signal in response to each of the plurality of sampling clock signals to generate the modified image signal.

2. The display apparatus of claim 1, wherein the transmitter further comprises a delay controller which compares the control clock signal with the plurality of sampling clock signals and generates a delay control signal, and the delay buffer delays the data signal in response to the delay control signal.

3. The display apparatus of claim 2, wherein the sampling clock signals comprise a first sampling clock signal by which a sampling operation of the sampler is initiated, and
the delay controller compares the control clock signal with the first sampling clock signal and generates the delay control signal according to a result of the comparison.

4. The display apparatus of claim 2, wherein the delay controller compares the control clock signal with the plurality of sampling clock signals, detects a delay time of the plurality of sampling clock signals from the control clock signal, and generates the delay control signal based on the delay time and a period of the control clock signal.

5. The display apparatus of claim 4, wherein the delay buffer delays the data signal when the delay time is substantially equal to or longer than the period of the control clock signal.

6. The display apparatus of claim 4, wherein the delay controller comprises:
a first and a second flip-flop which output high level output signals in response to the control clock signal and the first sampling clock signal, respectively;
a NOR operator which performs a NOR operation on the high level output signals to generate a NOR output;
a third flip-flop which generates an first output based on the NOR output in response to the control clock signal;
a fourth flip-flop which generates an second output based on the NOR output in response to an inverted control clock signal; and
an AND operator which performs an AND operation on the first and the second output to generate the delay control signal.

7. The display apparatus of claim 2, wherein the delay buffer comprises:
one or more delay units which delays the data signal; and
a selector which selectively outputs the delayed data signal in response to the delay control signal.

8. The display apparatus of claim 7, wherein the number of the delay units are more than two, and each of the delay units delays the data signal by a multiple of a period of the control clock signal.

9. A method of driving a display apparatus, the method comprising:
comparing a control clock signal with a plurality of sampling clock signals;
delaying a data signal according to whether the plurality of sampling clock signals has been delayed with respect to the control clock signal based on the comparison;
providing the delayed data signal to a sampler;
sampling the delayed data signal in response to the plurality of sampling clock signals to generate an image signal which comprises data information and data clock information embedded in the data information by using the sampler;
receiving the image signal and sampling the data information from the image signal using the data clock information; and
generating a data voltage corresponding to the data information.

10. The method of claim 9, wherein the sampling clock signals comprise a first sampling clock signal which initiates the sampling of the delayed data signal and the delaying of the data signal comprises comparing the control clock signal with the first sampling clock signal.

11. The method of claim 9, wherein the delaying of the data signal comprises:
comparing the control clock signal with the plurality of sampling clock signals and detecting a delay time of the plurality of sampling clock signals from the control clock signal; and
delaying the data signal based on the delay time and a period of the control clock signal.

12. The method of claim 11, wherein the data signal is delayed when the delay time is substantially equal to or longer than a period of the control clock signal.

13. The method of claim 12, wherein the data signal is delayed by a multiple of a period of the control clock signal when the delay time is longer than the period of the control clock signal.

14. The method of claim 9, wherein the image signal is a differential pair signal including a first signal and a second signal, and the differential pair signal is divided into a first section including the data information and a second section including the data clock information, wherein an absolute value of a difference between levels of the first and second signals in the first section is different from an absolute value of a difference between the levels of the first and second signals in the second section.
